(19) United States
(12) Patent Application Publication
(10) Pub. No.: US 2012/0102601 A1
(43) Pub. Date: Apr. 26, 2012

(54) SCANNING PROBE MICROSCOPE

(75) Inventors: Mun Seok JEONG, Buk-gu (KR); Kyoung-Duck Park, Buk-gu (KR); Seung Gol Lee, Nam-gu (KR)

(73) Assignee: GWANGJU INSTITUTE OF SCIENCE AND TECHNOLOGY, Buk-Gu (KR)

(21) Appl. No.: 13/279,763

(22) Filed: Oct. 24, 2011

(30) Foreign Application Priority Data
Oct. 26, 2010 (KR) 10 2010 0104426

(51) Int. Cl. G01Q 30/20

(52) U.S. Cl. 850/18

(57) ABSTRACT

Disclosed herein is a scanning probe microscope having an improved structure to precisely control a distance between a scanning probe and a surface of a sample. The scanning probe microscope includes a sample stage having a support structure on which a sample to be measured is placed and generating vibration, and a scanning probe not attached to the sample stage but independently constituted and scanning a surface of the sample placed on the sample stage and vibrated by the sample stage.

### CROSS-REFERENCE TO RELATED APPLICATION

This application claims the benefit under 35 U.S.A. §119 of Korean Patent Application No. 10-2010-0104426, filed on Oct. 26, 2010 in the Korean Intellectual Property Office, the entirety of which is incorporated herein by reference.

### BACKGROUND

1. Technical Field

The present invention relate to a scanning probe microscope and more particularly to a scanning probe microscope which measures a surface profile of a sample while measuring optical properties thereof as needed.

2. Description of the Related Art

A scanning probe microscope is a device that measures the surface height of a target sample to be observed, with a sharp probe tip moving in every direction over the sample surface. Since a general optical microscope is based on far-field measurement and thus undergoes light diffraction, the optical microscope has a resolution limit of about 200 nm. On the other hand, a scanning probe microscope measures a surface profile of a sample using a scanning probe with a tip of tens of nanometers and thus may overcome a resolution limit of the optical microscope.

A near-field scanning optical microscope (NSOM) is a type of scanning probe microscope, which measures the surface height of a target sample and optical properties thereof at the same time while moving a long probe having a sharp tip with a considerably small aperture of 100 nm or less in every direction over the sample surface.

FIGS. 1 and 2 are schematic views of a conventional vibrating scanning probe. Referring to FIGS. 1 and 2, the conventional vibrating scanning probe includes a tuning fork 1 equipped with a detection circuit (not shown) to detect changes in amplitude and phase and a scanning probe 3 attached to the vibrating tuning fork 1 via an adhesive 5 and having a tip 3a with a cross-section of several microns or less, and detects changes in shear force applied between the scanning probe 3 and the surface of a sample (not shown) to control the distance between the scanning probe 3 and the sample surface.

In a distance control method of such a vibrating scanning probe as described above, alternating current (AC) having a predetermined frequency is applied to the tuning fork 1 bonded to the scanning probe 3 to vibrate the tuning fork 1 and the scanning probe 3. Then, the scanning probe 3 is moved close to the sample surface to reduce vibration of the scanning probe 3 by shear force between the scanning probe 3 and the sample surface, so that vibration of the tuning fork 1 decreases. The detection circuit detects changes in amplitude and phase of the vibration, thereby controlling the distance between the scanning probe 3 and the sample surface.

Here, when output voltage of the tuning fork 1 is investigated while changing the frequency of AC voltage applied to the tuning fork 1, the output voltage records highest at a resonant frequency of the tuning fork 1 and decreases with increasing difference between the resonant frequency and the frequency of the applied AC voltage. Here, a value obtained by dividing the resonant frequency by a half amplitude of a frequency response curve is defined as a Q factor, and the degree of precision in controlling the distance between the scanning probe 3 and the sample surface is determined by the Q factor of the tuning fork 1. When the scanning probe 3 approaches the sample surface within 20 nm or less, shear force is detected to change physical properties of the tuning fork 1 and to move the frequency response curve to the left or right. Here, AC voltage applied to the tuning fork 1 has the resonant frequency of the tuning fork 1 when the shear force is not detected, that is, before the physical properties are changed by the shear force. Thus, as the frequency response curve moves to the left or right, the output voltage of the tuning fork 1 decreases. In view of the degree of precision in controlling the distance between the scanning probe 3 and the sample surface, when the same strength of shear force is applied to a scanning probe 3 in a tuning fork 1 having a high Q factor and a scanning probe 3 of a tuning fork 1 having a low Q factor to horizontally move resonance frequencies of the tuning forks 1 by the same extent, the tuning fork 1 having the high Q factor undergoes a considerable change in output voltage and the tuning fork 1 having the low Q factor undergo a small change in output voltage.

That is, the greater Q factor of the tuning fork 1, the more sensitively shear force is detected. Further, the more sensitively the scanning probe microscope detects shear force, the more precisely the scanning probe microscope controls the distance between the scanning probe 3 and the sample surface.

However, when the scanning probe 3 is attached to the tuning fork 1 in the conventional vibrating scanning probe, a Q factor decreases to about 1/20 or less. FIGS. 3a and 3b show frequency response curves of a bare tuning fork, a tuning fork with a sample, and a tuning fork with a scanning probe. As shown in FIGS. 3a and 3b, the Q factor decreases, since mass unbalance occurs between two prongs (divided portions) of the tuning fork 1, resistance applied to the tuning fork 1 increases, and the tuning fork 1 and the scanning probe 3 have different natural frequencies, causing loss of energy involved in vibrating the tuning fork 1. In particular, since the NSOM uses a long scanning probe 3, there is a substantial decrease in Q factor, which causes serious problems in precisely controlling the distance between the scanning probe 3 and the sample surface. Thus, it is difficult to measure at a high resolution a nano-sized sample that requires high-resolution measurement or a soft sample that requires controlling the distance between a scanning probe and a sample surface at a high sensitivity.

### BRIEF SUMMARY

The present invention provides a scanning probe microscope having an improved structure to precisely control the distance between a scanning probe and a surface of a sample.

In accordance with an aspect of the present invention, a scanning probe microscope includes a sample stage having a support structure on which a sample to be measured is placed and generating vibration, and a scanning probe separated from the sample stage and scanning a surface of the sample placed on the sample stage and vibrated by the sample stage.

The scanning probe microscope may detect shear force generated by vibration of the sample stage to control a distance between the scanning probe and the sample surface when the scanning probe approaches the sample.

The sample stage may be a tuning fork which receives alternating current (AC) and vibrates at a natural frequency of 100 Hz to 200 MHz.

The sample stage may be a quartz transducer which receives AC voltage and vibrates at a natural frequency of 100 Hz to 200 MHz.

The sample stage may be a piezoelectric actuator (PZT) which receives AC voltage and vibrates at a natural frequency of 100 Hz to 200 MHz.

A scanning direction of the scanning probe may be parallel or perpendicular to a vibration direction of the sample stage.

### BRIEF DESCRIPTION OF THE DRAWINGS

The above and other aspects, features, and advantages of the invention will become apparent from the following detailed description of exemplary embodiments in conjunction with the accompanying drawings, in which:

FIGS. 1 and 2 are schematic views of a conventional vibrating scanning probe;

FIG. 3a is a graph showing a frequency response curve of a bare tuning fork;

FIG. 3b is a graph showing a frequency response curve of a tuning fork with a scanning probe attached thereto;

FIG. 4 is a schematic view of a scanning probe microscope according to an exemplary embodiment of the present invention;

FIG. 5 is a graph of output voltage of a tuning fork according to a distance between a scanning probe and a surface of a sample, measured at a distal end, at the middle, and at a proximal end of a prong of the tuning fork by the scanning probe microscope according to the embodiment of the present invention;

FIG. 6 illustrates that a scanning direction of the scanning probe is perpendicular to a vibration direction of the turning fork in the scanning probe microscope according to the embodiment of the present invention;

FIG. 7a is a topography of a surface profile of neurons, showing an NSOM image of the neurons obtained by scanning the neurons placed on the vibrating tuning fork and illuminated by a 405 nm-wavelength laser from a lateral side while moving the scanning probe in a 2×2 um² area and at a unit moving step of 10 nm in the scanning direction shown in FIG. 6;

FIG. 7b is an image obtained by measuring intensity of light scattered on the neurons using the scanning probe;

FIG. 7c is a line profile graph depicting the height of a blue dotted line in the topography;

FIG. 8 is a schematic view of a scanning probe microscope according to another exemplary embodiment of the present invention;

FIG. 9a is a topography of a surface profile of neurons, showing an NSOM image of the neurons obtained by scanning the neurons placed on a non-vibrating tuning fork shown in FIG. 8 and illuminated by a 405 nm-wavelength laser from a lateral side while moving the scanning probe microscope of FIG. 8 in a 2×2 um² area and at a unit moving step of 10 nm;

FIG. 9b is an image obtained by measuring intensity of light scattered on the neurons using the scanning probe; and

FIG. 9c is a line profile graph depicting the height of a blue dotted line in the topography.

### DETAILED DESCRIPTION

Exemplary embodiments of the invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. The scope of the invention is limited only by the accompanying claims and equivalents thereof. Like reference numerals refer to like elements throughout the specification.

Herein, the exemplary embodiments of the invention will be described with reference to a near-field scanning optical microscope (NSOM) as an illustrative example of a scanning probe microscope. The NSOM is generally known in the art, and descriptions of details not directly related to technical features of the present invention will be omitted.

A scanning probe microscope according to exemplary embodiments of the present invention will now be described in detail with reference to the accompanying drawings.

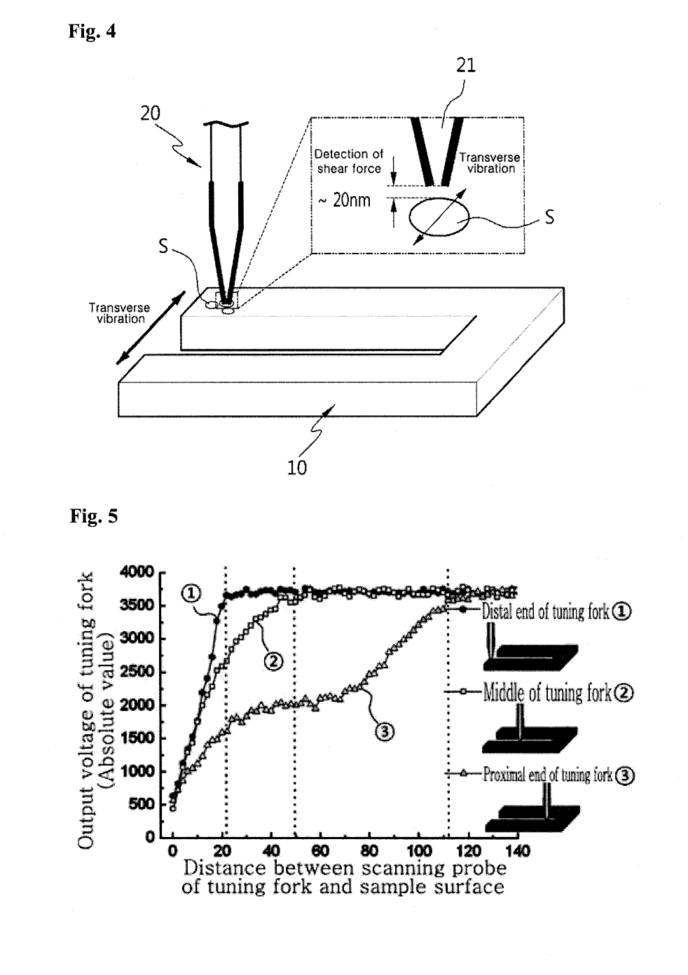

FIG. 4 is a schematic view of a scanning probe microscope according to an exemplary embodiment of the present invention.

Referring to FIG. 4, the scanning probe microscope according to the embodiment includes a sample stage 10 and a scanning probe 20.

The sample stage 10 has a horizontal support structure such that a sample S to be measured is placed thereon. In the embodiment, a tuning fork (hereinafter, indicated by reference numeral 10) is used as the sample stage 10. The tuning fork 10 is an acoustic resonator in the form of a two-pronged U-shaped narrow metal bar that emits sound of a particular frequency. The tuning fork 10 is generally known in the art, and descriptions thereof will be omitted herein.

The tuning fork 10 receives AC voltage from an AC voltage generator (not shown) and vibrates at a natural frequency of 100 Hz to 200 MHz, thereby vibrating the sample S on the tuning fork 10. Here, when AC voltage of a predetermined frequency is applied to the turning fork 10, the tuning fork 10 vibrates in a transverse direction (in an arrow direction of FIG. 4) such that the two prongs of the tuning fork 10 repeatedly narrow and widen. Further, a detection circuit (not shown) is mounted on the tuning fork 10 to detect changes in amplitude and phase of vibration of the tuning fork 10.

In this embodiment, the tuning fork is illustrated as an example of the sample stage 10, but the present invention is not limited thereto. The sample stage 10 may be a quartz transducer or a PZT that vibrates at a natural frequency of 100 Hz to 200 MHz when AC voltage is applied thereto. The quartz transducer and the PZT are generally known in the art, and descriptions thereof will be omitted herein.

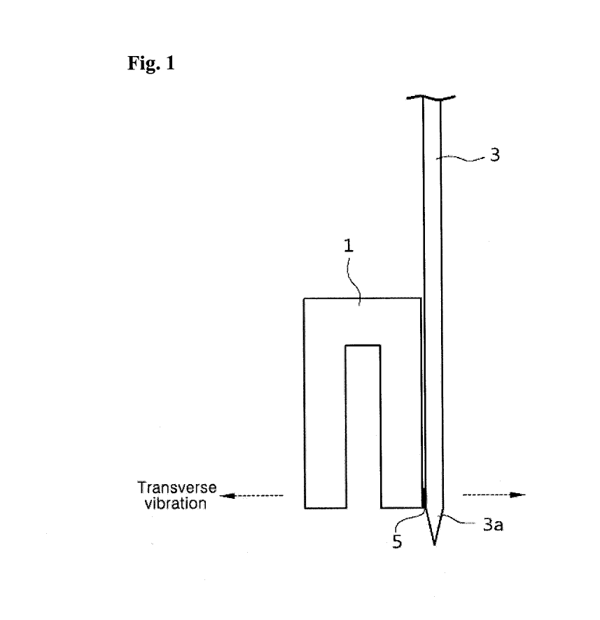

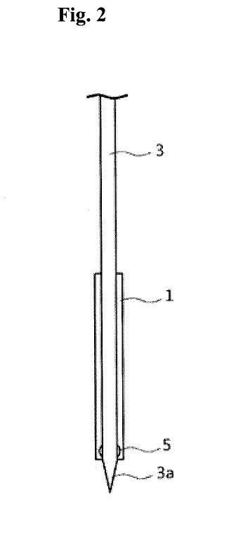

The scanning probe 20 is independently constituted instead of being attached to the tuning fork 10. That is, the conventional scanning probe 3 (see FIGS. 1 and 2) is attached to the vibrating turning fork 1, whereas the scanning probe 20 of this embodiment is a separate component placed on the tuning fork 10 used as the sample stage, instead of being attached to the vibrating tuning fork 10.

The scanning probe 20 is placed on the tuning fork 10 and scans the sample surface vibrated by the tuning fork, while moving in every direction. The scanning probe 20 has a probe tip 21 with a cross-section of several microns or less and may be formed of optical fibers. The scanning probe 20 is generally known in the art, and descriptions thereof will be omitted herein.

The scanning probe microscope according to the present embodiment of the invention is a new-type NSOM system, which employs the tuning fork 10 not attached to the scanning probe 20 as a vibrating sample stage and uses resonance of the tuning fork 10 to precisely control the distance between the scanning probe 20 and the surface of the sample S. The sample S placed on the tuning fork 10 vibrates at the same resonant frequency as the tuning fork 10, and as the scanning probe 20 approaches the sample to within about 20 nm, a varied resonant frequency is detected by the detection circuit to control the distance between the scanning probe 20 and the surface of the sample S. Here, shear force means Van der Waals' force generated between the probe tip 21 of the scanning probe 20 and the surface of the sample S when the scanning probe 20 approaches the surface of the sample S to within 20 nm or less.

As in a conventional NSOM, shear force is detected by two parts, that is, the probe tip 21 of the scanning probe 20 and the surface of the sample S, in the present embodiment. However, since the tuning fork 10 according to the present embodiment is used as a sample stage, instead of being attached to the scanning probe 20, the tuning fork 10 has a remarkably high Q factor as compared with the conventional NSOM shown in FIGS. 1 and 2. As a result, resonant properties of the tuning fork 10 having a remarkably high Q factor (up to 8,000) are used to detect shear force to enhance vertical resolution, thereby precisely controlling the distance between the scanning probe 20 and the surface of the sample S. Here, a value obtained by dividing the resonant frequency of the tuning fork 10 by a half amplitude of a frequency response curve is defined as a Q factor, and the degree of precision in controlling distance between the scanning probe 20 and the surface of the sample S is determined by the Q factor. Here, the greater the Q factor of the tuning fork 10, the more sensitively shear force is detected. Further, the more sensitively the scanning probe microscope detects shear force, the more precisely the scanning probe microscope controls the distance between the scanning probe 20 and the surface of the sample S.

Further, since it is not necessary to attach the tuning fork 10 to the scanning probe 20, the scanning probe microscope according the present embodiment has a simpler configuration than the conventional NSOM and a user does not need experienced skill in use of the NSOM.

Further, the scanning probe microscope according the present embodiment may be widely used in the field of measuring a soft sample requiring a high sensitivity between the scanning probe 20 and the surface of the sample S, such as a nano-scale sample or biological sample that requires high-resolution measurement.

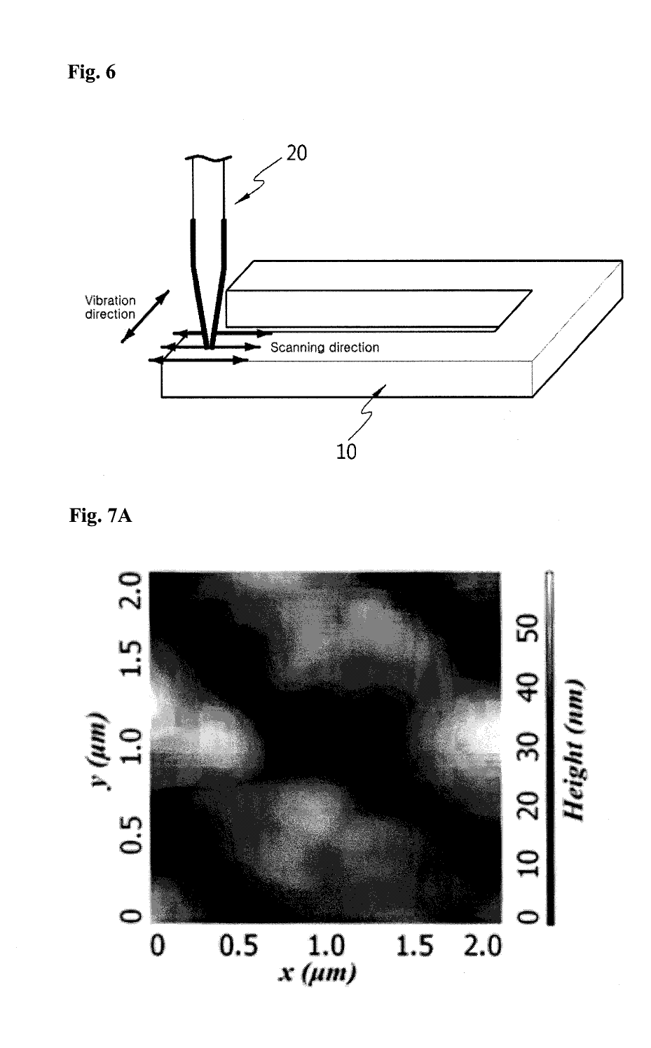

FIG. 5 is a graph of output voltage of a tuning fork according to a distance between a scanning probe and a surface of a sample, measured at a distal end, at the middle, and at a proximal end of a prong of the tuning fork by the scanning probe microscope according to the embodiment of the present invention.

In order to identify sensitivity of shear force sensed by the scanning probe 20 and the tuning fork 10 of the scanning probe microscope according to the present embodiment, changes in output voltage of the tuning fork 10 were observed while moving the scanning probe 20 close to the tuning fork 10. Since the tuning fork 10 vibrates in the form that two prongs repeatedly narrow and widen, the amplitude of vibration is considered to vary along the prongs. Thus, an approach curve was measured at three points around a distal end of a prong of the tuning fork 10, the middle thereof, and a proximal end thereof, and results are shown in the graph of FIG. 5. As shown in FIG. 5, in NSOM measurement using the scanning probe microscope according to the present embodiment, the sample S reacted to shear force most sensitively when placed on the distal end of the prong of the tuning fork 10.

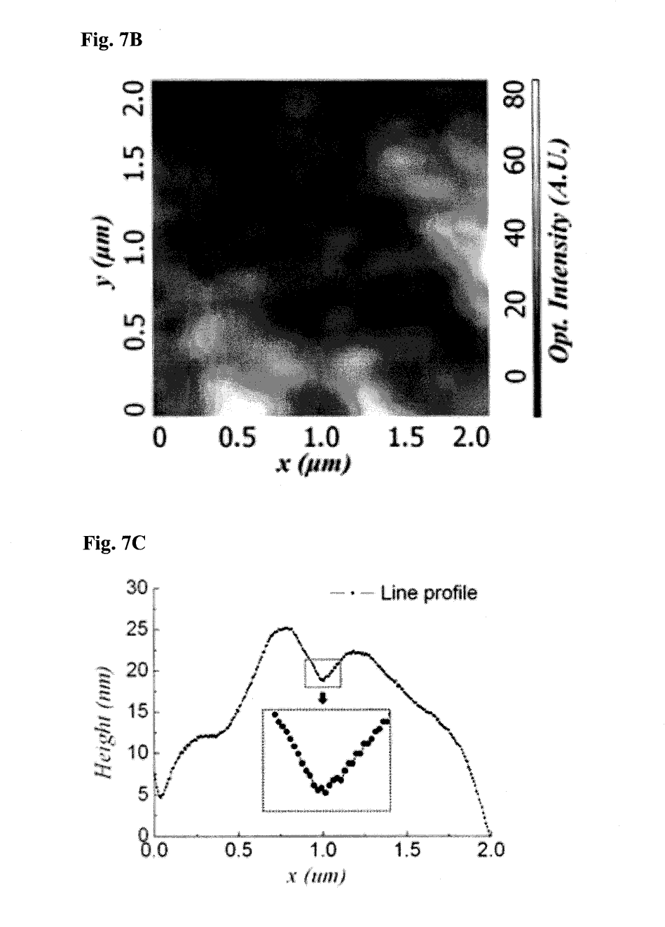

In order to identify performance of the scanning probe microscope according to the present embodiment, a test was conducted as in FIGS. 6 to 9.

FIG. 6 illustrates that a scanning direction of the scanning probe is perpendicular to a vibration direction of the turning fork in the scanning probe microscope according to the embodiment of the present invention.

Prior to the test, the tuning fork 10 was washed for about 30 minutes using an ultrasonicator in order to eliminate impurities from the surface of the tuning fork 10. Then, the washed surface of the tuning fork 10 was observed using an optical microscope and a sample S is placed thereon. The sample S was neurons obtained from a human neuroblastoma cell line. The neurons obtained from the human neuroblastoma cell line were cultured into about 12,000 cells, which in turn were diluted with a 10 μl culture solution, thereby preparing a sample solution to be observed. Then, a drop of the sample solution was put on a distal end of the prong of the tuning fork and cultured for 4 hours in a CO₂ incubator at 37° C. to secure the cells to the surface thereof. The secured neurons were treated with a 4% paraformaldehyde solution at room temperature for 20 minutes, washed with a phosphate buffer saline (PBS) solution and distilled water, and dried in air to evaporate moisture from the surface of the neurons.

Then, the neurons were illuminated by a 405 nm-wavelength laser from a lateral side to be scattered, and an optical fiber probe coated with metal and having a 100 nm aperture was moved close to the sample S to scan the sample S while collecting scattered light. Intensity of the collected light was converted into voltage using a photomultiplier tube and stored in an NSOM program.

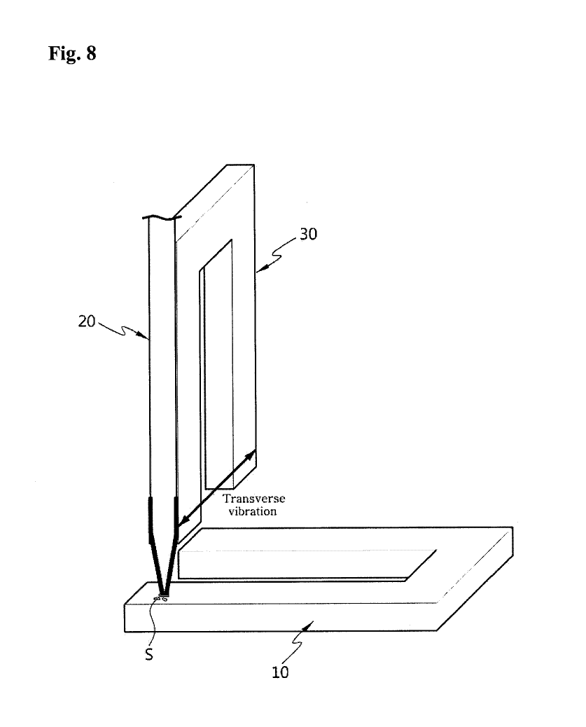

After illuminating the dried neurons using a 405 nm-wavelength laser from the lateral side, NSOM images were obtained by scanning the sample S while moving the scanning probe 20 in a 2×2 um² area and at a unit moving step of 10 nm in the scanning direction perpendicular to the vibration direction of the tuning fork 10, as shown in FIG. 6. The results are shown in FIGS. 7a and 7b. FIG. 7a is a topography of a surface profile of the neurons, FIG. 7b is an image obtained by measuring the intensity of light scattered on the neurons using the scanning probe, and FIG. 7c is a line profile graph depicting the height of a blue dotted line in the topography.

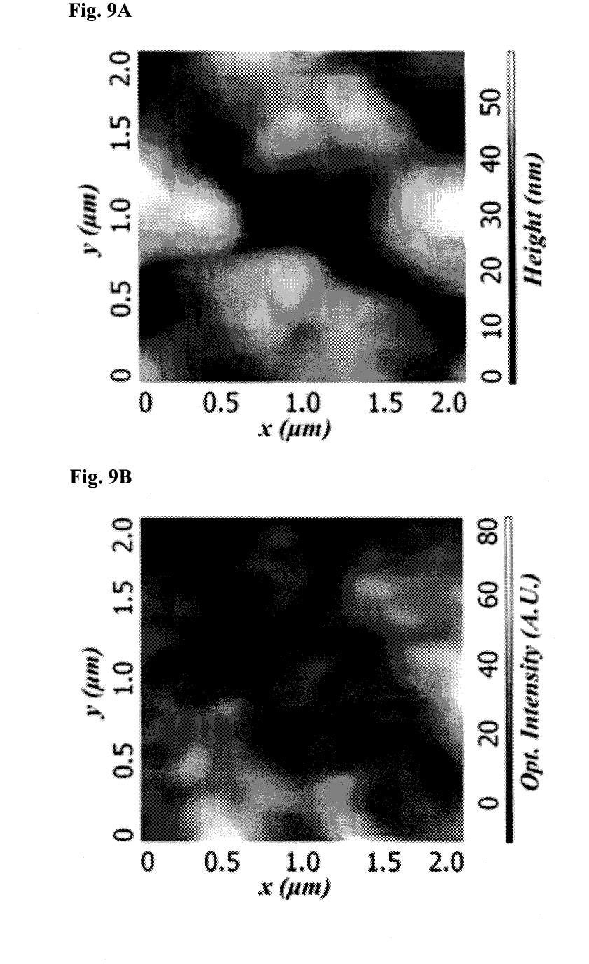

FIG. 8 is a schematic view of a scanning probe microscope according to another exemplary embodiment of the present invention.

Referring to FIG. 8, the scanning probe microscope according to this embodiment includes a sample stage 10, a scanning probe 20, and a vibration generator 30.

Unlike the above embodiment in which the vibrating tuning fork is used as a sample stage, a first non-vibrating tuning fork (hereinafter, indicated by reference numeral 10) is used as a sample stage in this embodiment.

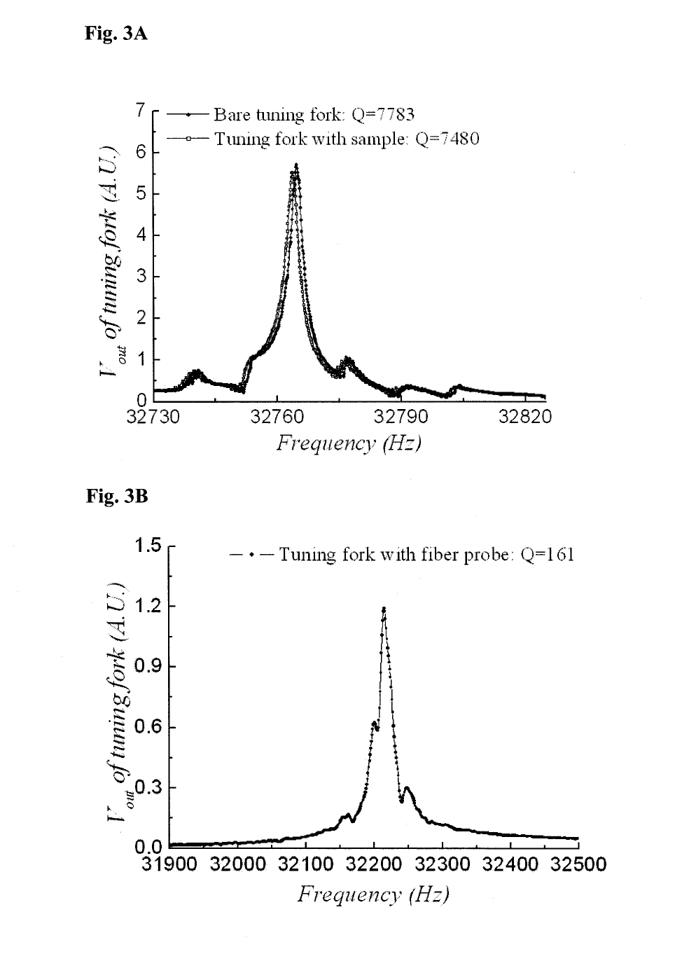

Instead of being attached to the first tuning fork 10, the scanning probe 20 is independently constituted and placed on the first tuning fork 10 used as the sample stage. Here, the scanning probe 20 is the same as the scanning probe of the scanning probe microscope according to the above embodiments shown in FIGS. 1 to 7.

The vibration generator 30 is bonded to the scanning probe 20 via adhesives (not shown) and vibrates the scanning probe 20. The vibration generator 30 is a second tuning fork (hereinafter, indicated by reference numeral 30), which is disposed perpendicularly to the first tuning fork 10 horizontally disposed and receives AC voltage from an AC generator (not shown) to vibrate.

That is, the scanning probe microscope according to this embodiment may be constituted by the conventional scanning probe microscope shown in FIGS. 1 and 2 which uses the non-vibrating tuning fork 10 as the sample stage.

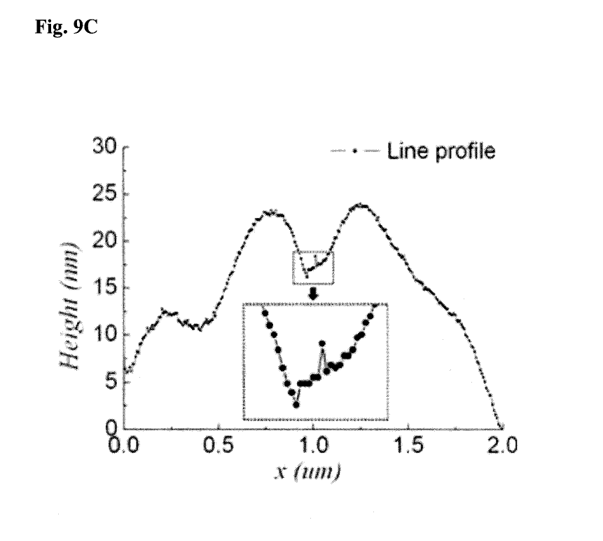

NSOM images obtained by the scanning probe microscope according to this embodiment are shown in FIG. 9.

FIG. 9 shows NSOM images obtained in the same area as in FIG. 7 using the scanning probe microscope according to the other embodiment when the first tuning fork 10 having the sample S placed thereon is not vibrated and the conventional second tuning fork 30 having a Q factor of about 150 and the scanning probe 20 are used.

As shown in FIG. 9, the scanning probe microscope according to this embodiment has a slightly inferior resolution to that in FIG. 7, and this result is considered to be caused by the tuning fork having a lower Q factor than the Q factor of the tuning fork according to the above embodiment.

As such, in the scanning probe microscope according to exemplary embodiments, a tuning fork is used as a sample stage, instead of being attached to a scanning probe, and thus the scanning probe microscope has a remarkably high Q factor of the tuning fork as compared with a conventional scanning probe microscope. The remarkably high Q factor of the tuning fork is used to control the distance between the scanning probe and the surface of a sample, so that the scanning probe microscope has a considerably high vertical resolution and a high degree of precision.

Further, since it is not necessary to attach the tuning fork to the scanning probe, the scanning probe microscope has a simple configuration and a user does not need considerable skill in use of the scanning probe microscope.

In addition, the scanning probe microscope is used to measure a nano-scale sample that requires a high vertical resolution or to measure a soft sample that requires a high sensitivity in detecting shear force between the scanning probe and a sample.

Although some embodiments have been described herein, it should be understood by those skilled in the art that various modifications, variations, and alterations can be made without departing from the spirit and scope of the present invention. Therefore, it should be understood that these embodiments are given by way of illustration only and are not in any way construed as limiting the present invention. The scope of the present invention should be limited only by the accompanying claims and equivalents thereof.

What is claimed is:

1. A scanning probe microscope comprising:
a sample stage having a support structure, on which a sample to be measured is placed, and generating vibration; and
a scanning probe separated from the sample stage and scanning a surface of the sample placed on the sample stage and vibrated by the sample stage.

2. The scanning probe microscope of claim 1, wherein the scanning probe microscope detects shear force generated by vibration of the sample stage and controls a distance between the scanning probe and the sample surface when the scanning probe approaches the sample.

3. The scanning probe microscope of claim 1, wherein the sample stage comprises a tuning fork which receives alternating current (AC) to vibrate.

4. The scanning probe microscope of claim 3, wherein the tuning fork vibrates at a natural frequency of 100 Hz to 200 MHz.

5. The scanning probe microscope of claim 1, wherein the sample stage comprises a quartz transducer which receives AC voltage to vibrate.

6. The scanning probe microscope of claim 5, wherein the quartz transducer vibrates at a natural frequency of 100 Hz to 200 MHz.

7. The scanning probe microscope of claim 1, wherein the sample stage comprises a PZT which receives AC voltage to vibrate.

8. The scanning probe microscope of claim 7, wherein the PZT vibrates at a natural frequency of 100 Hz to 200 MHz.

9. The scanning probe microscope of claim 1, wherein a scanning direction of the scanning probe is parallel or perpendicular to a vibration direction of the sample stage.
